(19) United States
(12) Patent Application Publication
(10) Pub. No.: US 2003/0116505 A1
(43) Pub. Date: Jun. 26, 2003

(54) Magnetic fluid filter

(76) Inventor: Stewart D. Elsegood, Balmoral Beach (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/032,276

(22) Filed: Dec. 21, 2001

(51) Int. Cl. C02F 1/48

(52) U.S. Cl. 210/695; 210/222; 210/223; 210/440

(57) ABSTRACT

A magnetic fluid filter for filtering metallic particles from a fluid flow system. The filter comprises a cylindrical case, a magnetic array, a support for the magnetic array, and fluid line connection pieces for incorporation of the filter into a fluid flow line. The magnetic array includes a plurality of disc shaped magnets arranged with poles in opposition, interleaved with disc shaped pole pieces.

### BACKGROUND OF THE INVENTION

1. Field of the Invention

The present invention relates to a filter, and more particularly a magnetic filter for removing solid particles from a fluid.

2. Description of the Related Art

It is common practice to use fluids to lubricate moving parts of mechanical systems. Foreign particles are often shed by the mechanical system in operation into the lubricating fluid where it can cause wear and damage to the operating system and its components. Many mechanical systems already make use of primary filters to remove foreign particles from the lubricating fluid of the system such as oil filter cartridges in an automobile engine or transmission system.

The majority of contaminant particles in a mechanical system are metallic in nature and therefore subject to magnetic attraction. For this reason, others have attempted to integrate magnets with conventional filters to provide removal of metallic particles. However, prior magnetic filters were typically limited in that their design was specific for a particular application environment. For example, the majority of current magnetic filters are limited to their application to engine oil filtration systems within automobiles. Moreover, such filters are typically connected to the external flow path of the fluid to be filtered.

Accordingly, it would be advantageous for a magnetic filter to have the capability of being integrated into any fluid system requiring filtering of metallic particles, and for the magnetic components in the filter to be in closer proximity to the direct flow of the fluid through the filtering device.

### SUMMARY OF THE INVENTION

A filter apparatus comprises a housing defining a chamber for the containment of a fluid, an inlet for receiving a fluid into the chamber, an outlet for outputting fluid from the chamber, and a magnetic array disposed within the chamber for removing metallic particles from the fluid, the magnetic array comprising at least two magnets disposed a distance apart from one another so that a polar repulsion force is maintained between the at least two magnets.

In the filter apparatus, the plurality of magnets can be disc shaped, and the at least two magnets can be held apart by pole pieces having a larger diameter than the magnets. The magnetic array may comprise 3, 4, 5 or 6 magnets disposed a distance apart from one another so that a polar repulsion force is maintained between each magnet and its nearest neighbor magnet. The filter inlet may comprise a first end piece configured to mount with a tube, and the outlet can comprise a second end piece configured to mount with a tube.

The filter apparatus may further comprise a plurality of spines protruding from the housing, and the spines can be configured to reversibly mount the filter apparatus to the inside of a conventional oil filter.

An apparatus for removing metallic particles from a fluid comprises a housing defining an elongated chamber for the containment of a fluid, having open ends and a fluid flow path through the chamber, a magnetic body centrally located within the chamber in the fluid flow path having magnetic means to attract and retain magnetically susceptible particles present in the fluid passing through the fluid flow path in the chamber, wherein the magnetic means comprises a plurality of magnets configured to maintain a magnetically repulsive force between at least two of the plurality of magnets. The apparatus may further comprise two end pieces for attaching to external fluid sources.

A fluid filter apparatus comprises a hollow cylindrical housing for the containment of a fluid having open ends and a fluid flow path, two end pieces having attaching means for communication with the open ends of the hollow cylindrical housing, attaching means for incorporation of the fluid filter into a fluid flow path of a system requiring filtering of a fluid, and a fluid flow path so as to allow fluid to flow into and out of the hollow cylindrical housing to and from the fluid flow path of the system requiring filtering of a fluid.

The fluid filter apparatus further comprises a magnetic array positioned centrally within the housing comprised of a plurality of disc shaped magnets arranged in a like-pole to like-pole orientation, wherein the magnets are separated by a plurality of disc shaped pole pieces, a magnet support positioned within the housing comprised of a frame, having an X shaped cross section, and having means for supporting the magnetic array in the hollow cylindrical housing but not fully encasing the magnetic array so as to allow fluid to flow over the magnetic array and through the hollow cylindrical housing.

In the fluid filter apparatus, the fluid can be power steering fluid, and the magnet support can be formed from a punched and folded piece of non-magnetic material. The magnet support may have a centrally located void having dimensions corresponding to those of the magnetic array, and outer dimensions corresponding to those of the inner of the hollow cylindrical housing.

In the fluid filter apparatus, the pole pieces can have a larger diameter than that of the magnets, and the magnet support can have voids so as to allow for the larger diameter of the pole pieces.

### BRIEF DESCRIPTION OF THE DRAWINGS

FIG. 1 is a cross-sectional assembly view of one embodiment of a magnetic fluid filter.

FIG. 2 is a cross-sectional view of one embodiment of a magnetic filter.

FIG. 3 is an illustration of a magnet support piece before it is folded.

FIG. 4A is a perspective view of the magnet support piece of FIG. 3 after a first fold is made.

FIG. 4B is a perspective view of the magnet support piece of FIG. 4 after a second fold is made.

FIG. 5 is a cross section view of the magnetic filter of FIG. 2 taken along the line 5-5.

FIG. 6A is a side view assembly stack illustration of a magnetic array.

FIG. 6B is a side view of the assembled magnetic array of FIG. 6A.

FIG. 7A is a cross sectional side view of an alternative embodiment of the magnetic filter and a cut away view of a conventional automobile oil filter.

FIG. 7B is a vertical view of the alternative embodiment of the invention of FIG. 7A.

FIG. 8 is a cut away view of a conventional oil filter with the magnetic filter of FIG. 7A installed.

### DETAILED DESCRIPTION OF THE PREFERRED EMBODIMENT

Embodiments of the invention relate to a magnetic fluid filter for filtering metallic particles from a fluid flow system. One example of such a fluid flow system is a power steering unit in an automobile. This embodiment includes a cylindrical outer casing mated to two end pieces for incorporating the filter into a fluid flow line.

Inside the magnetic fluid filter is an array of magnets that is held in place by a support. In one embodiment, the magnetic array has a plurality of disc shaped magnets separated by “pole pieces”. The magnets, each having a north pole and south pole, are arranged in a like-pole to like-pole configuration (north to north and south to south), and separated by the pole pieces. This configuration of magnetic like-poles creates a large magnetic gradient that attracts metallic particles to the surface of the array.

As can be imagined, embodiments of the invention are not limited to the specific magnetic array described above. For example, the magnetic array can include 3, 4, 5, 6 or more magnets disposed a distance apart from one another so that a polar repulsion force is maintained between each magnet and its nearest neighbor magnet.

The magnet support can be made from a folded and punched piece of nonmagnetic material, such as stainless steel. Notched or cut out sections within the support provide a nest for the magnetic array centrally along the length of the case such that fluid flowing through the case is within the effective range of the magnetic array. The pole pieces can have a larger diameter than that of the magnets such that as fluid flows over the array the pole piece provides a shelter on the downstream side of the pole piece for the magnetically attracted metallic particles in the fluid. Alternatively, the pole pieces can have a smaller diameter than the magnets to provide a reservoir for the magnetically attracted metallic particles.

The arrangement of the magnets within the cylindrical case allows fluid flow in either direction. In addition to bidirectional fluid flow, because there is no device that can be filled or blocked, the filter can allow full flow of fluid at all times.

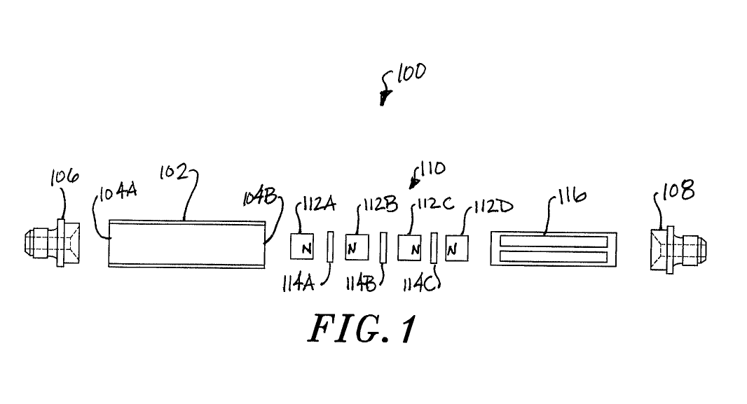

FIG. 1 is a cross-sectional assembly view of a magnetic fluid filter 100. The filter 100 comprises a hollow cylindrical case 102 that is preferably made of a nonmagnetic material. The case 102 has two circular open ends 104A, B into which a first and second hollow end pieces 106, 108 can be secured. The end pieces 106, 108 allow for installment of the filter 100 into any fluid line such that the end pieces 106, 108 provide secure attachment to the fluid flow system and an inlet and/or outlet whereby fluid is allowed to flow inside the case 102 of the filter 100. The end pieces 106, 108 can be of a screwed connection type, barb connection, or direct to hose swage connection, or any combination thereof.

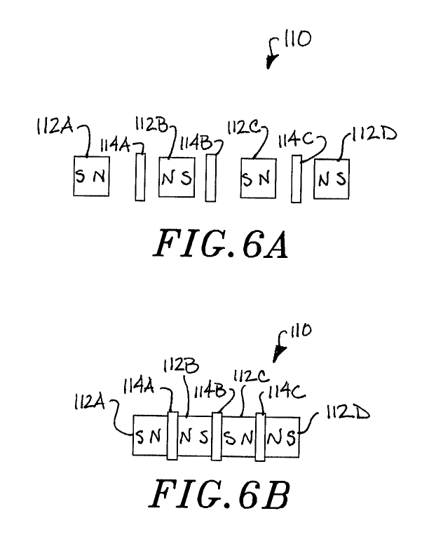

The case 102 allows containment of fluid flow over a magnetic array 110 that is disposed within the case 102. The magnetic array 110 includes a series of magnets 112A-D arranged in a like-pole-to-like-pole arrangement, whereby each magnet is separated by a pole piece 114A-C. The magnets 112 and pole pieces 114 are preferably disc shaped. In addition, the pole pieces 114 can vary in width, and in one embodiment are much more narrow than the magnets 112. The pole pieces 114 can be manufactured from a magnetic material, such as iron or steel, and are slightly larger in diameter than the magnets 112A-D in order to provide shelter on the downstream side of the pole piece. The magnetic array 110 will be discussed in further detail with respect to FIGS. 6A and 6B. A magnet support 116 is also illustrated in FIG. 1, and is configured to support the magnetic array 110 within the case 102.

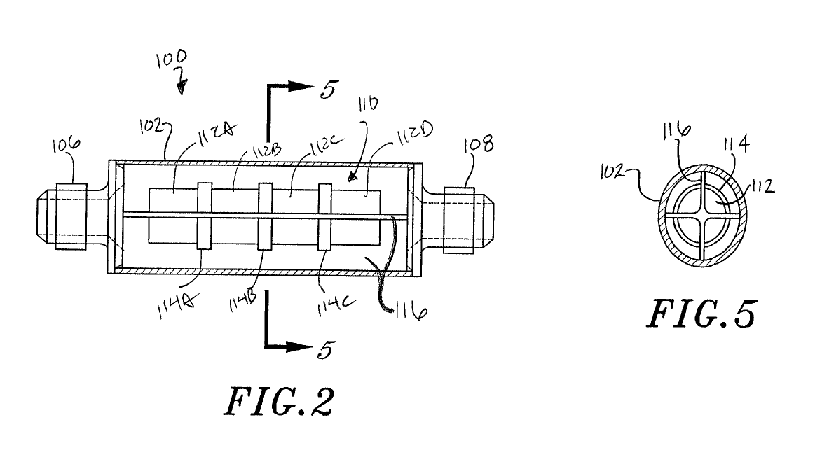

A cross-sectional view of the assembled magnetic filter 100 is shown in FIG. 2. The magnet support 116 is contained within the case 102 by contacting the inner wall of the case 102, but allowing for end caps or means for secure attachment of the case 102 to a fluid flow system. As shown, the assembled array 110 is supported within the case 102 by the support 116 extending the length of the case 102. Also shown in FIG. 2 are the end pieces 106, 108 installed on the filter 100 to provide a fluid inlet and outlet to the interior of the case 102.

As can be seen in FIG. 2, as fluid enters the filter 100 it flows over the magnetic array 110 and through the case 102. Therefore, irrespective of the direction of fluid flow, metal particles will be filtered out of the fluid by the magnetic array 110. The filter 100 can therefore be installed in a fluid path irrespective of the direction of fluid flow.

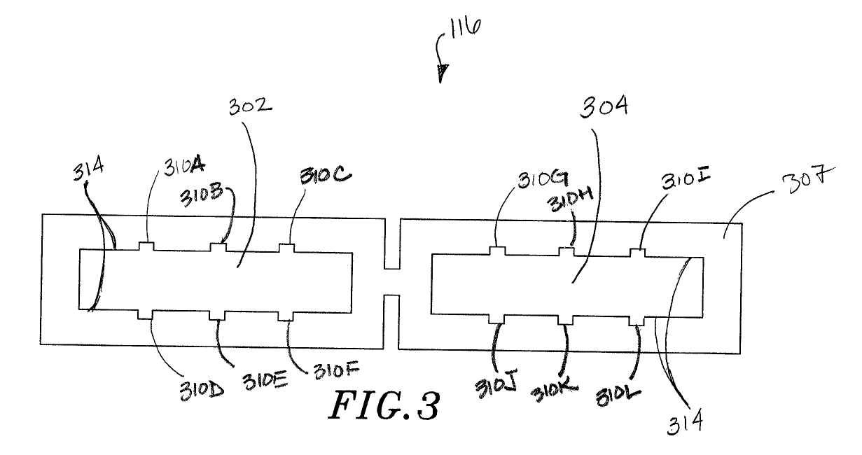

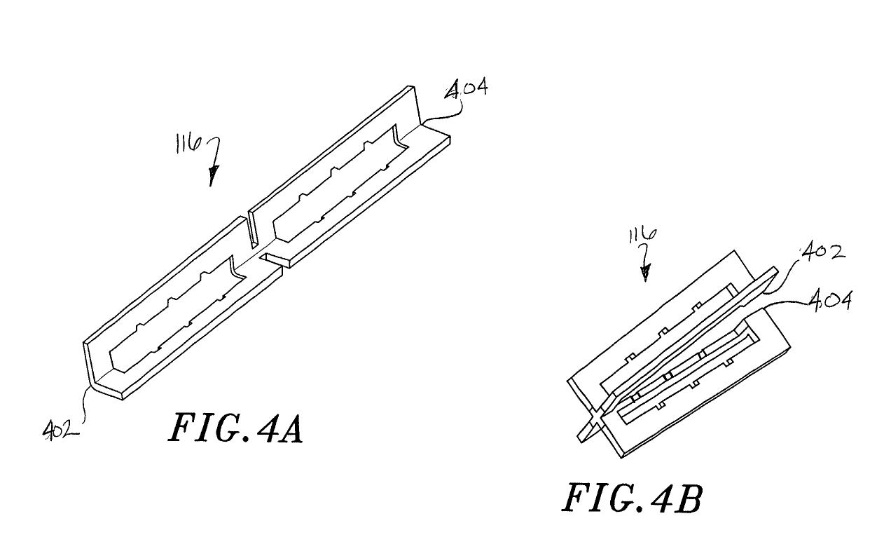

Referring now to FIG. 3, in this embodiment the magnet support 116 is comprised of a punched, and then folded flat, piece of stainless steel or other non-magnetic material. The magnet support 116 is formed by punching two voids 302, 304 in a flat piece of steel 307 so that when it is folded, it will have a length corresponding to that of the array 110, and a width corresponding to the diameter of the array 110 (See FIGS. 4 and 5). A plurality of notches 310A-L, having a width corresponding to the width of the pole piece 114, and a depth corresponding to the difference in radius between that of the pole piece 114 and that of the magnet 112, are formed in the inner edges 314 of the magnet support 116. As can be imagined, the larger diameter pole pieces 114A-C can then be mounted inside of the notches 310A-L when the steel 307 is folded into the proper conformation. Of course, it should be realized that the magnetic support is not limited to being formed from steel, and can be made from any support material, such as metal or plastic.

Once the proper notches are formed in the steel 307, a first, right angle fold is made along the longitudinal center-line of the punched piece of steel 116 so as to form comers 402, 404 on either end of the punched piece 116 as indicated in FIGS. 4A, B. A second, 180° angle fold is then made along a center axis of the punched piece 116, perpendicular to the axis of the first fold, such that the two comers 402, 404 formed from the first fold are adjacent to one another.

Referring back to FIG. 3, when the magnet support 116 is folded to its final geometry surrounding the magnetic array 110, the magnetic array 110 is secured along four longitudinal inner edges 314 of the support on the peripheral surfaces of the magnets 112A-D and pole piece 114A-C. The outer surfaces of the magnets 112A-D and pole pieces 114A-C are then in contact with the inner edges 314 of the magnet support 116. When the folded magnetic support 116 is placed within the case 102 (See FIGS. 2 and 5), the magnetic disks 112A-D and pole pieces 114A-C are held in place by the inward force placed on the support 116 from the case 102.

A cross-section of the magnetic array 110 supported in the case 102 along line 5-5 is shown in FIG. 5. As can be seen in FIG. 5, the folded magnet support 116 forms an “X” shape along the cross section. Of course, the magnet support 116 can be of any geometry, such as any frame having a void corresponding to the shape and dimensions of the magnetic array 110 but not fully encapsulating the array 110, so as to support the array 110 in an effective position in the fluid flow path through the filter 100.

The magnetic array 110 will now be discussed in further detail with reference to FIGS. 6A and 6B. The like-pole-to-like-pole arrangement of the magnets 112A-D creates a magnified magnetic attraction at the area where the poles are held apart by the pole piece 114A-C. The design presented by the magnetic array 110 increases the amount of non-homogeneous magnetic field produced by a fixed volume of magnetic material.

A magnetic field gradient is necessary to attract ferro-magnetic or metal particles, and to hold them in the filter 100. The magnetic attraction force provided by the magnetic field gradient should be greater than competing forces. In this case the competing forces are provided by gravity and fluid flow through the filter 100, wherein even if the fluid flow is great, the filtered particles are simply spread along the length of the array 110. One embodiment of the invention can obtain field gradients as high as 30T/m close to the pole pieces 114A-C in the array 110. An additional advantage to the array 110 is that it can be more powerful than expensive rare earth magnets, and it is also not affected in performance by heat, as are rare earth magnets.

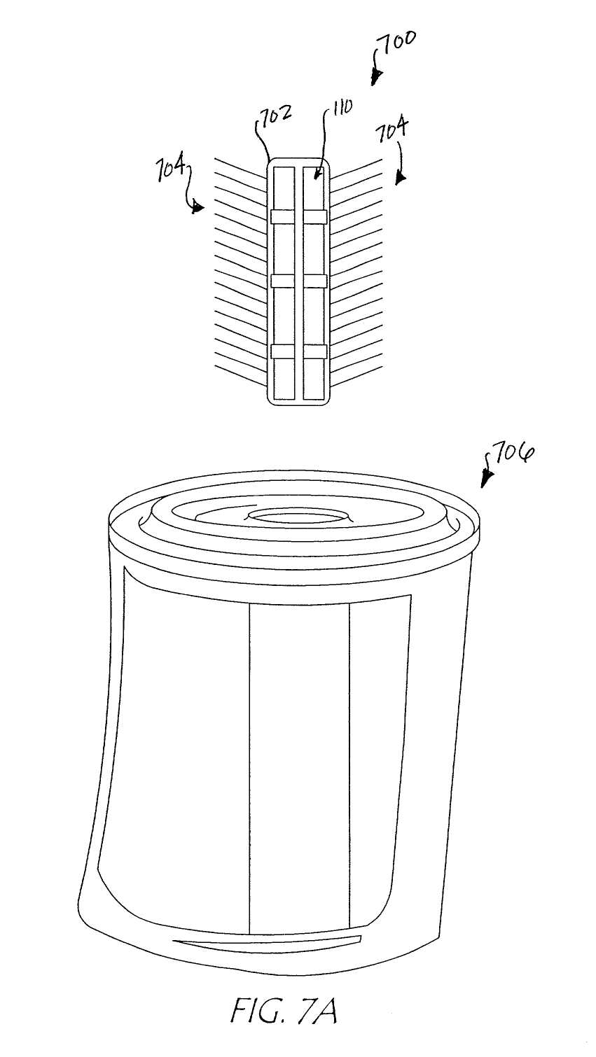

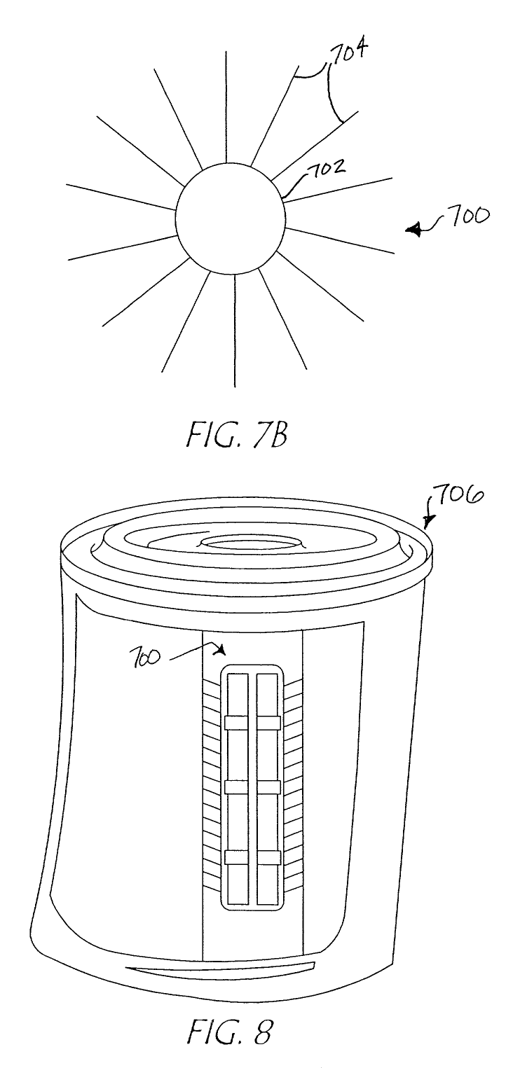

FIGS. 7A and 7B illustrate a cross sectional view of an alternative embodiment of a magnetic filter 700. The filter 700 comprises the magnetic array 110 as described previously, however a plastic sleeve 702 is disposed around the exterior of the array 110. As shown, the sleeve 702 has a plurality of elastic branches or spines 704 protruding from its outer surface. The spines 704 are designed to be folded back along the sleeve 702 such that the filter 700 can be slidably inserted into the center return shaft of a conventional oil filter 706.

FIG. 7B provides a top view of the filter 700 and its plurality of protruding spines 704 protruding from the sleeve 702. Alternatively, the spines 704 can be directly mounted or incorporated with the magnetic filter 700 along an outer surface of the case 702.

FIG. 8 is a cut-away side view of the filter 700 installed in the conventional oil filter 706. The spines 704 are configured to spring outward when installed in the oil filter 704 to hold the filter 700 in position. As oil flows past the magnetic surface of the array 110 metal contaminants are collected on the filter 700.

Although a preferred embodiment of the filter of the present invention has been discussed in the preceding section, the invention is not limited to this embodiment. Other embodiments which capture the spirit of the invention are also anticipated. The scope of the invention is not limited to the embodiments discussed above, but is only limited by the following claims.

What is claimed is:

1. A filter apparatus comprising:
a housing defining a chamber for the containment of a fluid;
an inlet for receiving a fluid into said chamber;
an outlet for outputting fluid from said chamber; and
a magnetic array disposed within said chamber for removing metallic particles from said fluid, said magnetic array comprising at least two magnets disposed a distance apart from one another so that a polar repulsion force is maintained between said at least two magnets.

2. The filter apparatus of claim 1, wherein said plurality of magnets are disc shaped.

3. The filter apparatus of claim 1, wherein said at least two magnets are held apart by pole pieces having a larger diameter than said magnets.

4. The filter apparatus of claim 1, wherein said magnetic array comprises 3, 4, 5 or 6 magnets disposed a distance apart from one another so that a polar repulsion force is maintained between each magnet and its nearest neighbor magnet.

5. The filter apparatus of claim 1, wherein said inlet comprises a first end piece configured to mount with a tube.

6. The filter apparatus of claim 5, wherein said outlet comprises a second end piece configured to mount with a tube.

7. The filter apparatus of claim 1, further comprising a plurality of spines protruding from said housing.

8. The filter apparatus of claim 7, wherein said spines are configured to reversibly mount said filter apparatus to the inside of a conventional oil filter.

9. An apparatus for removing metallic particles from a fluid, comprising:
a housing defining an elongated chamber for the containment of a fluid, having open ends and a fluid flow path through said chamber; and
a magnetic body centrally located within said chamber in said fluid flow path having magnetic means to attract and retain magnetically susceptible particles present in said fluid passing through said fluid flow path in said chamber, wherein said magnetic means comprises a plurality of magnets configured to maintain a magnetically repulsive force between at least two of said plurality of magnets.

10. The apparatus of claim 9, further comprising two end pieces for attaching to external fluid sources.

11. The apparatus of claim 9, wherein said magnets are disc shaped.

12. The apparatus of claim 9, further comprising a plurality of spines protruding from said housing.

13. The filter apparatus of claim 12, wherein said spines are configured to reversibly mount said filter apparatus to the inside of a conventional oil filter.

14. A fluid filter apparatus comprising:
a hollow cylindrical housing for the containment of a fluid having open ends and a fluid flow path;
a magnetic array positioned within the housing comprised of a plurality of disc shaped magnets arranged in a like-pole to like-pole orientation; and
a magnet support positioned within the housing having means for supporting the magnetic array in the hollow cylindrical housing such that fluid is allowed to flow over the magnetic array and through the hollow cylindrical housing.

15. The filter of claim 14, wherein said fluid is power steering fluid.

16. The filter of claim 14, wherein said magnet support comprises an X-shaped cross section.

17. The filter of claim 14, wherein the fluid is oil.

18. The filter of claim 17, comprising attaching means for attaching the filter to an engine.

19. A filter for the removal of metallic particles from a fluid, said filter comprising:
a housing for the containment of a fluid having open ends and a fluid flow path;
attaching means for fluidly connecting the filter into a fluid flow path of a system requiring filtering of a fluid, so as to allow fluid to flow into and out of the housing; and
a magnetic body disposed within the housing and configured to attract and retain magnetically attractable particles present in the fluid flow path through the filter.

20. The filter of claim 19, wherein said magnetic body comprises a plurality of disc shaped magnets separated by a plurality of disc shaped pole pieces, wherein said magnets are thicker than said pole pieces.

21. The filter of claim 19, wherein said system is an engine.

22. The filter of claim 19, further comprising a frame disposed within said housing and supporting said magnetic body.

23. A method of removing metallic particles from a fluid, comprising:
providing a magnetic body within a fluid path, said magnetic body comprising a plurality of magnets configured to maintain a magnetically repulsive force between at least two of said plurality of magnets; and
contacting said fluid with said magnetic body, wherein said contact results in said metallic particles being magnetically attracted to said magnetic body and removed from said fluid.

24. The method of claim 23, wherein said metallic particles are from an engine.

25. The method of claim 23, wherein said fluid is oil.

26. The method of claim 25, wherein said magnetic body is positioned inside an oil filter.

27. The method of claim 23, wherein said magnets are disc shaped elements.
